(19) United States
(12) Patent Application Publication
(10) Pub. No.: US 2017/0363780 A1
(43) Pub. Date: Dec. 21, 2017

(54) LENTICULAR PRODUCT

(71) Applicant: SPORTS EDUCATION IN MOTION, Arlington, VA (US)

(72) Inventors: Peter KEBIS, Arlington, VA (US); Radovan PLETKA, Arlington, VA (US)

(21) Appl. No.: 15/527,668

(22) PCT Filed: Nov. 19, 2015
(86) PCT No.: PCT/US15/61576

§ 371 Date: May 17, 2017

Related U.S. Application Data
(60) Provisional application No. 62/081,981, filed on Nov. 19, 2014.

(51) Int. Cl. G02B 3/00; G02B 27/12; G02B 27/22; G09B 19/00

(52) U.S. Cl. CPC G02B 3/005; G09B 19/003; G02B 27/123; G02B 27/2214

(57) ABSTRACT

Lenticular products and methods of manufacturing. A lenticular product can include a lenticular sheet having a front surface and a back surface, the front surface including an array of lenticular lenses. Images can be printed on the back surface of the lenticular sheet, and each of the images can be arranged into frames interlaced with other frames corresponding to other images, wherein each of the frames is aligned with a lenticular lense such that light reflected from frames associated with a same image are refracted in a same direction and frames reflected from frames associated with a different image are refracted in a different direction. The lenticular can include a backing layer having a first surface coupled to the back surface of the lenticular sheet and a second surface opposite of the first surface. The backing layer can include instructions and/or images on the second surface representing a sports move.

### CROSS-REFERENCE TO RELATED APPLICATIONS

This application claims the benefit of U.S. Provisional Application No. 62/081,981, filed on Nov. 19, 2014, entitled “LENTICULAR PRODUCT”, the content of which is incorporated herein by reference in its entirety.

This application is related to U.S. Pat. No. 8,605,359, filed on Sep. 11, 2012, entitled “LENTICULAR PRODUCT”, the content of which is incorporated herein by reference in its entirety.

### BACKGROUND

### 1. Technical Field

The present disclosure relates to lenticular products and more specifically to manufacturing, rendering, and implementation of lenticular products.

### 2. Introduction

Lenticular printing is a technology used to produce images that create optical illusions of depth, movement, or animation when viewed from different angles. Frames from an image representing the various views of a desired illusion can be interlaced to create the desired illusion. Lenticular lenses can be placed over an interlaced image to magnify different frames when viewed from different angles. Here, the lenticular lenses can refract light from different angles to bring different frames from the interlaced image into focus. The desired illusion is then rendered by our brain as the interlaced image is viewed from different angles.

To achieve the desired illusion, the lenticular lenses can be aligned and arranged with the interlaces. In fact, faulty printing and misaligned construction can have significant consequences, and may even prevent rendering of the desired optical illusion. Indeed, imprecise printing and construction often lead to image quality issues, such as poor resolution, or improper rendering. However, when properly constructed, lenticular products can be used to render a wide range of images, capable of producing interesting and unique optical illusions. Unfortunately, lenticular products are currently limited, and fail to adequately leverage lenticular technologies in a wide range of applications, such as functional implementations, to provide precise and robust lenticular solutions.

### SUMMARY

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

The approaches disclosed herein can be used to produce and manufacture a lenticular product for a wide range of applications. These approaches can be used to create a lenticular card providing an instructional, animated image(s) with functional instructions provided on a backing layer of the lenticular card. The lenticular effect created by the card can illustrate an action, such as a sports move. The functional instructions can then provide details on how the action illustrated through the lenticular effect can be performed. This way, a user can view the back of the lenticular card to review instructions on how to perform a move or an action, and can refer to the front of the card to view an animated illustration of the move or action. This configuration can be implemented in other formats and contexts. A context can refer to formats, forms, applications, designs, purpose, product type, information type, categories, topics, composition of product, or any other implementation characteristic. For example, this configuration can be implemented in books, forms, pamphlets, instructional guides, displays, signs, walls, doors, windows, panels, or any other object. Other contexts can include educational contexts, instructional contexts, sports contexts, activities, guides, safety instructions, advertisements, commercials, product labels or guides, shopping maps and directories, entertainment products, or any other context.

Disclosed are lenticular products and methods of manufacturing lenticular products. A lenticular product can include a lenticular sheet having a front surface and a back surface, the front surface including an array or plurality of lenticular lenses. The lenticular lenses can be lenticules arranged over the lenticular sheet. The lenticules can have longitudinal, cylindrical axes distributed over the lenticular sheet. In some cases, the lenticules can be arranged parallel to each other. Moreover, the size and shape of the lenticules can vary based on the images used to create the lenticular effect, as well as the shape and size of the lenticular product or the specific application. In some cases, the front surface of the lenticular sheet can be irregular or non-planar, due to the irregular shape and size of the lenticular lenses. However, the front surface can be coated with a coating material that can fill any gaps or grooves created by the irregular shape and size of the lenticular lenses. In some embodiments, the front surface can include an optical window created over a portion of the lenticular sheet. The window can be significantly flat or planar, and can allow light beams to traverse the window without distortion or with minimal distortion.

A first set of images can be printed on the back surface of the lenticular sheet. Each of the first set of images can be arranged into frames. The frames can be interlaced with other frames corresponding to similarly arranged images from the first set of images. Each of the frames can be aligned with at least one of the lenticular lenses such that light reflected from frames associated with a same image are refracted in a same direction and frames reflected from frames associated with a different image are refracted in a different direction. Such refraction of light can create a lenticular effect. The lenticular lenses and the first set of images can be arranged and aligned based on the particular lenticular effect desired. For example, the arrangement and alignment can vary based on whether the lenticular effect desired is an animation, a motion, a flashing effect, a movement, an illusion of depth, a video, etc.

In some embodiments, the first set of images can include multiple images which together can provide the graphical content or views necessary to achieve the desired lenticular effect. However, in other embodiments, the first set of images can refer to a single image having the necessary graphical content or views to achieve the desired lenticular effect. For example, the first set of images can refer to a single graphic material including one or more images or, alternatively, the first set of images can refer to a single image depicting multiple views. In any case, the first set of images can provide all of the necessary pixels for generating the desired lenticular effect. For example, if the desired lenticular effect is to show a movement of a soccer player in a series of poses, the first set of images can include an image depicting the soccer player in the series of poses. Moreover, the first set of images can include graphic material, photographs, pictures, cartoons, painted materials, or any other type of illustration or printed material.

The images can be segmented into various portions or sections, which can make up the frames, and the segmented portions or sections making up the frames can be interlaced. The interlaces can then be arranged and aligned with the lenticular lenses to create the lenticular effect required. The lenticular effect can be created by movement or changes in the angle or position of the lenticular product relative to the surrounding light and/or the viewer's eyes. For example, the lenticular effect can be created by a change of angle and/or distance of the lenticular product with respect to a viewer's eyes. Here, the light can be refracted from particular frames depending on the angle, position, or distance of the viewer's eyes or light relative to the lenticular product. As the angle, position, or distance of the lenticular product relative to the light or viewer's eye change, different frames can be magnified or brought into focus by the lenticular lenses, so as to create the desired lenticular effect.

The lenticular product can also include a backing layer having a first surface coupled to the back surface of the lenticular sheet and a second surface opposite of the first surface. The backing layer can include instructions and/or a second set of images printed on the second surface of the backing layer. The second plurality of images can represent a series of actions or steps. The instructions can also correspond to the series of actions or steps and/or the movement represented by the first set of images. For example, the backing layer can have images printed showing various movements needed to perform a particular action. In some cases, the particular action can also be illustrated by the lenticular effect created by the lenticular product based on the first set of images and the lenticular lenses. The instructions can provide details for performing each step of the action(s) depicted by the images. In some cases, the second set of images can include subsets of images displayed over different areas of the second surface of the backing layer. For example, the second surface of the backing layer can have areas depicting various steps or stages of an action based on a subset of images and/or instructions.

In some cases, the lenticular product can further include an adhesive layer on the first surface of the backing layer coupled to the back surface of the lenticular sheet. The lenticular product can also include a coating deposited or provided over a portion of the front surface of the lenticular sheet. The coating can be a clear coating that allows light to pass through the coating. In some cases, the coating can fill gaps or spaces between the lenticular lenses on the front surface of the lenticular sheet. Such gaps or spaces can result from the shapes of the lenticular lenses and/or the front surface of the lenticular sheet. To this end, the front surface of the lenticular sheet can include grooves, which as mentioned before can be at least partially filled by the coating material. On the other hand, the back surface of the lenticular sheet can, in some cases, be significantly flat or planar.

In some embodiments, the images and/or instructions in the lenticular product can be based on an application, topic, or subject requiring at least some form of movement, position, step, activity, gesture, motion, or action. Some example applications include, but are not limited to, sports, yoga, physical therapy, chiropractor exercises, fitness/workout, dancing, karate, tae kwon do, stretching, pregnancy labor, arts, crafts, acting, cooking, engineering, design, computing, building or repairing items, or any other activities.

Thus, for example, the lenticular product can be designed to provide a lenticular effect and/or instructions based on sports moves; yoga positions, steps, or movements; physical therapy exercises, positions, or activities; chiropractor exercises, movements, postures, or motions; fitness/workout exercises, steps, or movements; dancing movements, steps, positions, or choreographies; any steps, activities, movements, motions, or offensive/defensive moves and techniques in karate, tae kwon do, martial arts, boxing, or any self-defense discipline; stretching exercises, positions, or steps; pregnancy exercises (e.g., breathing or labor exercises), activities, movements, or positions; arts or crafts activities or steps; acting steps, movements, gestures, or motions; cooking steps or procedures; engineering steps or procedures; designing activities; computing activities; building or repairing items, or any other activities.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates a lenticular product in accordance with an exemplary embodiment;

FIG. 2 illustrates a view of a screen and mask assembly for a lenticular sheet in accordance with an exemplary embodiment;

FIG. 3 illustrates a configuration of a lenticular sheet with an optical window in accordance with an exemplary embodiment;

FIGS. 4A-D illustrate front views of a lenticular product in accordance with an exemplary embodiment;

FIG. 5 illustrates a back view of a lenticular product in accordance with an exemplary embodiment; and

FIG. 6 illustrates a method for manufacturing a lenticular product in accordance with an exemplary embodiment.

### DETAILED DESCRIPTION

Various embodiments of the disclosure are described in detail below. While specific implementations are described, it should be understood that this is done for illustration purposes only. Other components and configurations may be used without parting from the spirit and scope of the disclosure.

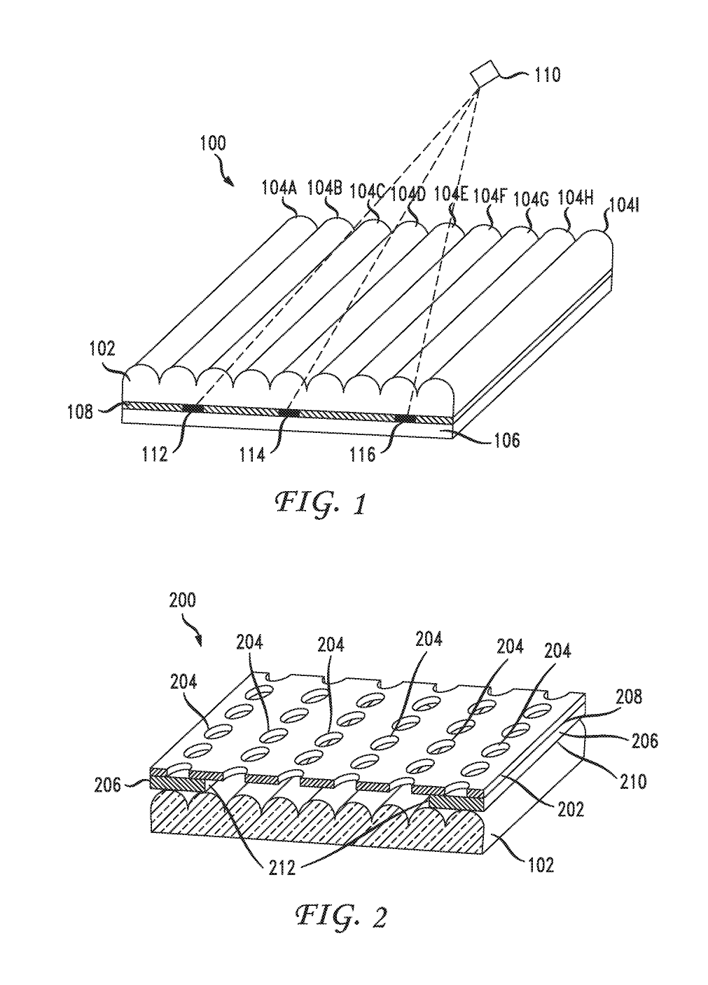

The present disclosure addresses the need for robust and accurate lenticular products suitable for a wide range of applications. Disclosed herein are lenticular products and methods of manufacture for lenticular products. A brief introductory description of an example lenticular product, as illustrated in FIG. 1, is disclosed herein. A more detailed description of lenticular products and methods of manufacture will then follow. Variations of lenticular products and concepts shall be described herein as the various embodiments are set forth. The disclosure now turns to FIG. 1.

FIG. 1 illustrates a lenticular product 100 in accordance with an exemplary embodiment. The lenticular product 100 can include a lenticular sheet 102 for producing a lenticular effect. The lenticular effect can include an animation, a movie, a motion, a movement, a 3D effect, a depth magnification effect, an illusion, a magnification or distortion of one or more images, or any other lenticular effect showing differences between images or views. Other lenticular effects will become readily apparent to one of ordinary skill in the art based on this disclosure. The lenticular effect can be generated using multiple images printed on the lenticular product 100. In some embodiments, the images can be printed on a back surface 108 of the lenticular sheet 102. In other embodiments, one or more of the images can be printed on a backing layer 106 of the lenticular product 100, which can be coupled to the lenticular sheet 102 according to a predetermined alignment. In still other embodiments, some of the images can be printed on the back surface 108 of the lenticular sheet 102, while other images can be printed on the backing layer 106 of the lenticular product 100.

Each of the images printed on the lenticular product 100 can represent a particular state of the image from the various states required to produce the desired lenticular effect. For example, if the desired lenticular effect is to show a person running, one of the images can show the person in the initial running stance, another image can show the person after taking a first running step, and one or more images can be used to show subsequent running steps. Thus, when printed in the lenticular product 100, the images, in combination with the lenticular sheet 102, can be shown to create the visual effect of the person running according to the various running positions displayed by the images. This effect can be generated by a light source 110 transmitting light to the lenticular product 100. The light source 110 can transmit natural light or any other type of light. As light hits the lenticular sheet 102, different portions of the images can be magnified to illustrate a particular view of the lenticular effect. The specific portions that are magnified depend on the angle of the light emitted from the light source 110. For example, a first angle of the light source 110 can cause the light to pass through the lenticular sheet 102 and be refracted from specific portions 112, 114, and 116 of the printed images to magnify those portions 112, 114, and 116. Accordingly, the images magnified at that specific angle will be the portions of the images depicted by the specific portions 112, 114, and 116. If the angle of the light emitted from the light source 110 changes, the portions magnified can change to other portions of the images.

The portions 112, 114, and 116 can represent different frames from the same image. For example, if the lenticular product 100 includes an image of a player in a first stance and a second image of the player in a second stance, the portions 112, 114, 116 can represent different frames from the first image or different frames from the second image. This way, if portions 112, 114, and 116 are magnified, they can create an illusion of a specific image, such as the first image, being magnified. If a different portion corresponding to frames on a different image, such as the second image, are then magnified, the different image will then appear to be magnified. This can create the illusion of the player going from the first stance, depicted in the first image magnified, to the second stance, depicted in the second image being magnified. An image can refer to any printed material. For example, an image can refer to a picture or photograph, or any graphic illustration or depiction.

To achieve this effect, the various printed images can be segmented into frames. The frames can then be interlaced. In other words, the frames from the various images can be aligned with the lenticular sheet 102 as well as the other frames in order to ensure that frames from a same image are magnified together in accordance with a same angle of light, and frames from other images are similarly magnified together when placed at same angles relative to the light from the light source 110. This can create the effect of a particular image being magnified at a specific angle, and a different image being magnified as the angle changes. Thus, when the lenticular product 100 is moved around to change the angle of the lenticular product 100 vis-à-vis the light from the light source 110 or the viewer's eyes, the different images are magnified by specific angles to produce the desired lenticular effect. The angle of rotation can be left to right, up and down, or any other change of angle between the lenticular product and the surrounding light, the light source 110, or the viewer's eyes. In some cases, the distance or position of the lenticular product with respect to the surrounding light, the light source 110, or the viewer's eyes can also trigger or affect the lenticular effect.

To produce the desired lenticular effect, the lenticular sheet 102 can include lenticular lenses 104A-I or lenticules. In other embodiments, more or less lenticular lenses can be used. The lenticular lenses 104A-I can be shaped so as to create grooves or waves on the surface of the lenticular sheet 102. The shape of the lenticular lenses 104A-I, and consequently the shape of the surface of the lenticular sheet 102, can change based on the size of the lenticular lenses 104A-I, the shape and size of the lenticular product 100, the shape and size of the printed images on the back surface 108 of the lenticular sheet 102, and/or the desired lenticular effect to be generated by the lenticular product 100. For example, the lenticular lenses can be bigger in an advertisement or billboard implementation, and smaller in a lenticular card or stamp implementation.

The lenticular lenses 104A-I can be aligned with the interlaced frames of the images so that light is refracted from the various frames in a way that results in the various frames being magnified. For example, lenticular lens 104C can be aligned with frame 112, lenticular lens 104E can be aligned with frame 114, and lenticular lens 104H can be aligned with frame 116. This way, when light passes through lenses 104C, 104E, and 104H, the light can be refracted from frames 112, 114, and 116, respectively, so that frames 112, 114, and 116 are perceived as being magnified by the human eye and brain. This way, when the light is refracted from frames 112, 114, and 116 at each angle, the human eye and brain will perceive the image corresponding to frames 112, 114, and 116 as being magnified or dominant over the other images. Thus, if the frames 112, 114, and 116 correspond to an image of a runner taking a first running step, the runner in the lenticular product 100 can be perceived as taking the first running step when the angle of the light with respect to the lenticular product 100 changes from a previous angle that magnified the frames of an image of the runner in an initial running stance to the frames 112, 114, and 116. Here, the lenticular lenses 104A-I, when hit with light from a previous angle, may have magnified or focused the frames of the runner in the initial running stance, and subsequently magnified or focused frames 112, 114, and 116 (i.e., the runner taking the first running step) when the angle changed, redirecting the light to refract from the adjacent frames from the interlaced frames. The result is that the human eye and brain will perceive the runner in the lenticular product 100 as taking a running step from an initial running stance.

Accordingly, the various images printed in the back surface 108 of the lenticular sheet 102 can be segmented into frames and the resulting frames interlaced to form an interlace. The interlace can then be aligned with the lenticular lenses 104A-I to ensure that light passing through the lenticular lenses 104A-I is refracted from the appropriate corresponding frame in the interlace so that a lenticular effect is created when the lenticular product 100 is moved in various angles with respect to the light source 110. In some cases, the alignment can be such that when the lenticular product 100 is at a particular angle relative to the light source 110, frames from a same image are magnified and frames from other images are faded, diminished, lightened, or hidden. As the angle of the lenticular product 100 changes, the light is refracted from different frames. In many cases, the frames magnified at any particular angle relative to the light source 110 belong to the same image, and the frames diminished, faded, lightened, or hidden belong to other images. This way, a specific image will be magnified at particular angles, and other images are magnified at other angles. Thus, an image can be magnified as long as there is light, and the specific image that is magnified depends on the angle of the lenticular product 100—and thus the angle of the lenticular lenses 104A-I and the images printed on the back surface 108—relative to the light source 110.

The lenticular lenses 104A-I can be clear or transparent to allow light pass through the lenses and refract from the back surface 108 and/or the backing layer 106. In other cases, the lenticular lenses 104A-I can be lightly colored to distort or modify the image, lenticular effect, or color perceived by the human eye and brain. In some embodiments, the lenticular lenses 104A-I can also be coated with a material in order to cover or fill any grooves or gaps on the surface of the lenticular sheet 102 created by the shape of the lenticular lenses 104A-I. This way, the lenticular sheet 102 can have a smooth look and feel despite the rounded—or otherwise non-planar—shape of the lenticular lenses 104A-I. The coating materials, in some cases, can be clear or transparent to reduce the amount of distortion or interruption of light refracted from the back surface 108 of the lenticular sheet 102.

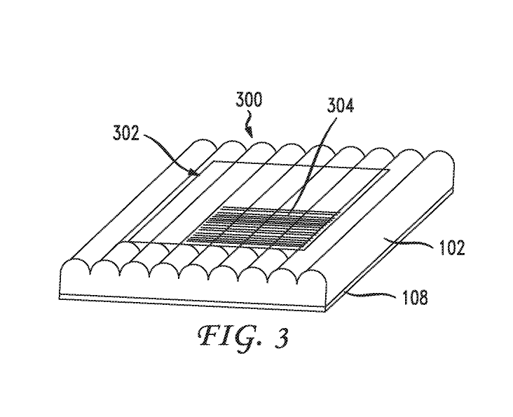

Having disclosed an example of a lenticular product 100, the disclosure now turns to FIG. 2, which illustrates a view 200 of a screen 202 and mask 206 assembly for the lenticular sheet 102 in accordance with an exemplary embodiment. A screen 202 having apertures 204 can be furnished with a mask 206. The mask can have a back face 208, a front face 210, and an inner sidewall 212. Moreover, the mask 206 can allow permeation of a coating material, which can be in fluid form, through the screen 202 and over a portion of the lenticular sheet 102. The screen 202 can allow coating material to permeate through the apertures 204, while preventing permeation through other areas.

The mask 206 can be formed from any material as one of ordinary skill in the art will readily recognize. For example, the mask 206 can be formed from plastic, rubber, cardboard, paper, fiberglass, metal, or any other non-fluid material. In some embodiments, the mask 52 can be formed according to a specific thickness and resilience as to conform to the lenticular lenses 104 in the lenticular sheet 102. The mask 206 can be placed over the lenticular sheet 102 and fitted to the lenticular lenses 104A-I to prevent bleeding from any fluid material used to coat the lenticular sheet 102.

The screen 202 can be adapted to the mask 206 so, together, the screen 202 and mask 206 can define an opening, basin, or reservoir suitable for receiving the coating material in a controlled manner. The coating material can thus be introduced through the screen 202 into the opening defined by the screen 202 and mask 206. The opening can then be filled with the coating material, and the screen 202 and mask 206 removed from the lenticular sheet 102. The coating material can then cover at least a portion of the lenticular lenses 104A-I on the lenticular sheet 102. If the coating material is fluid, the coating material can be allowed to congeal or otherwise change to a solid state. In some cases, the coating material can form a window over the surface. The window can be clear or transparent. Moreover, the window can be an optical window that allows light to pass through the window and be refracted from images printed on the back surface 108 of the lenticular sheet 102.

While FIG. 2 illustrates a screen 202 and mask 206 assembly, other suitable components are also contemplated herein. One of ordinary skill in the art will readily recognize that other components can alternatively be used to provide a coating material and/or an optical window on the lenticular product 100. Moreover, the screen and mask assembly are described for explanation purposes to show coating material being provided. Other embodiments which do not use a screen and mask assembly or provide a coating material at all are also contemplated herein.

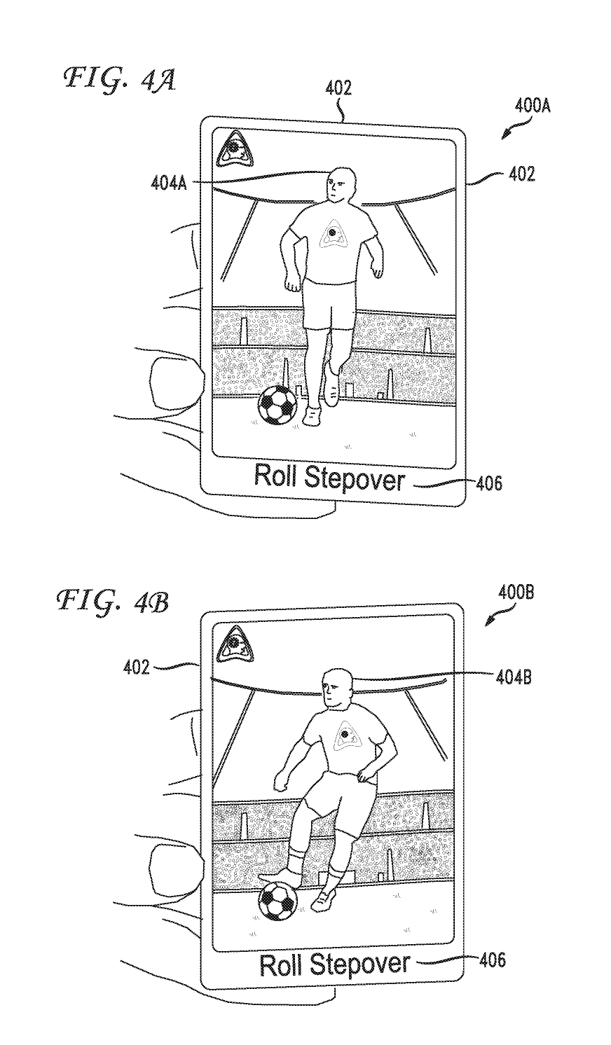

FIG. 3 illustrates a configuration 300 of a lenticular sheet 102 with an optical window 302 in accordance with an exemplary embodiment. The configuration 300 can be generated using the screen 202 and mask 206 assembly illustrated in FIG. 2. The configuration 300 can include a lenticular sheet 102 with a window 302 generated over one or more images 304 printed on the back surface 108 of the lenticular sheet 102. The one or more images 304 can include multiple images used to generate the desired lenticular effect, or a single image depicting various views according to the desired lenticular effect. Moreover, the window 302 can be an optical window configured to allow light to refract from the one or more images 304 on the back surface 108 of the lenticular sheet 102. In some cases, the window 302 can be clear or transparent. In other cases, the window 302 can have light color(s). In yet other cases, the window 302 can have any colored pattern or solid color, as long as some light is capable of being refracted from the images 304.

The window 302 can be created over a front-surface area of the lenticular sheet 102. However, in other cases, the window 302 can otherwise be created over an area of the lenticular lenses 104A-I. For example, the lenticular sheet 102 can be cut to have an open area according to the area of the window 302. Using the screen 202 and mask 206 assembly illustrated in FIG. 2, a coating material can then be poured over the open area in the lenticular sheet 102 to fill the open area with the coating material. If in liquid form, the coating material can then be left to solidify, harden, or congeal. The coating material can form the window 302 over the images 304 on the back surface 108 of the lenticular sheet 102.

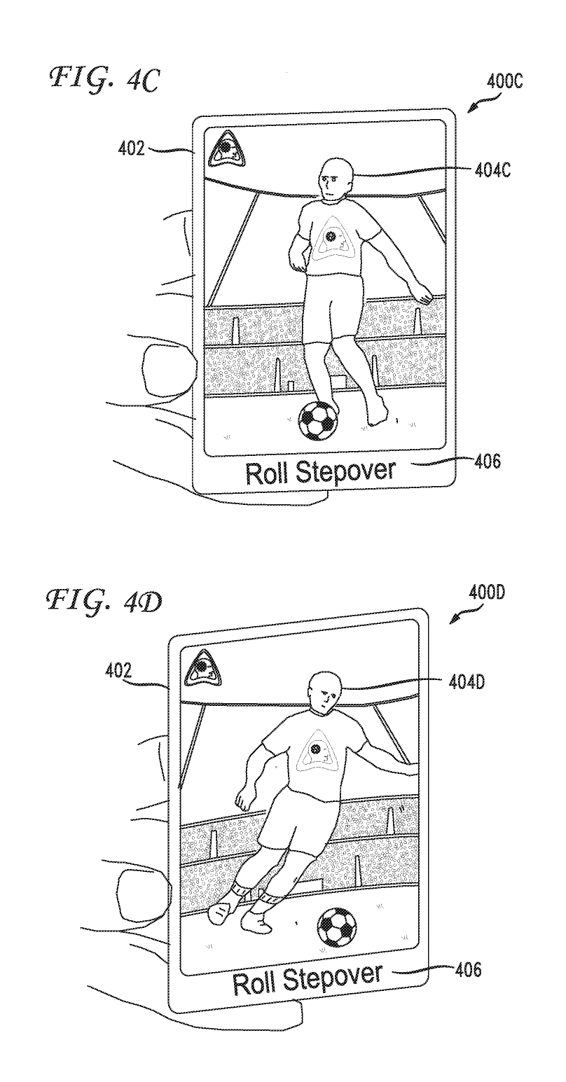

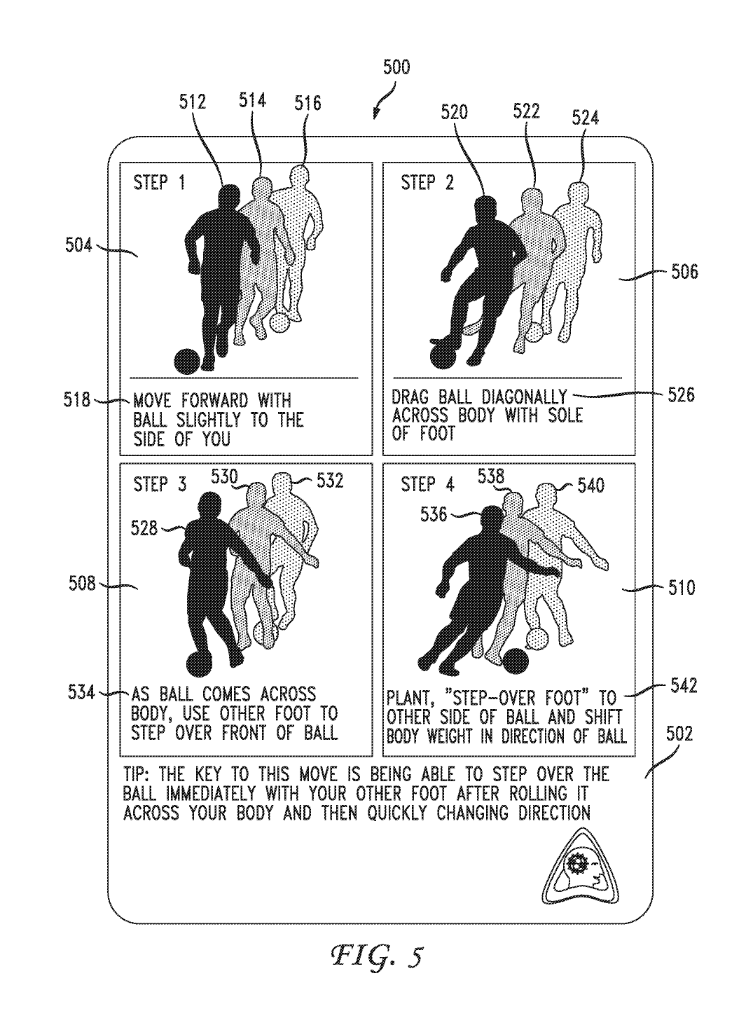

FIGS. 4A-4D illustrate front views 400A-400D of a lenticular product 402 in accordance with an exemplary embodiment. The lenticular product 402 can display different images 404A-404D depending on the specific angle of the lenticular product 402 relative to the surrounding light, the light source, or the viewer's eye. In some cases, the images 404A-404D can, but is not required to, correspond to a set of instruction panels on the back of the lenticular product 402. FIG. 5, below, illustrates instruction panels in accordance with an exemplary embodiment.

For example, for a step involving four moves, the instruction panels on the back can present four boxes or areas depicting the four moves to the step. Accordingly, the images 404A-404D can correspond to the four moves associated with the step. As another example, for a step involving five moves, the instruction panels on the back can present five boxes or areas depicting the five moves to the step, and the images 404A-404D on the front of the lenticular product 402 can correspond to the five moves associated with the step. However, in other cases, the images 404A-404D may not be matched every time with the instruction panels. For example, the last image from the images 404A-404D depicted in the front of the lenticular product 402 may correspond to the image(s) in the first box or area of the instruction panels on the back, if that is the goal. In yet other cases, the instructional panels may explain the difference between two consecutive images 404A-D. For example, image 404A can represent a step in a move, and one or more instructional panels corresponding to that particular step may explain any substeps for performing the particular step.

Each of the images 404A-404D can be configured to be magnified when light hits the lenticular product 402 at respective angles associated with the images 404A-404D. For example, at a first angle, the lenticular product 402 can illustrate a first image 404A. When the angle of the lenticular product 402 relative to the light changes, a second image 404B can be magnified into focus. When the angle of the lenticular product 402 relative to the light changes once again, the third image 404C can then be magnified into focus. Finally, if the angle of the lenticular product 402 relative to the light changes yet again, the fourth image 404D can be magnified into focus. If the angle of the lenticular product 402 relative to the light changes yet again, the third image 404C or the first image 404A can be magnified into focus depending on the angle or change of direction.

The relationship between the images 404A-404D magnified and the angle or position of the lenticular product 402 relative to the light can be based on a sequence. For example, the images 404A-404D can be arranged or aligned so that if the lenticular product 402 is held with the front surface of the lenticular product 402 facing the light or at a specific position relative to the viewer, a specific image from the images 404A-D would be magnified into focus.

If the lenticular product 402 is then tilted or rotated a threshold amount (e.g., 5, 10, or 20 degrees) or otherwise moved forward/backward or right/left a threshold amount relative to the viewer, the specific image from the images 404A-404D that is magnified into focus when the lenticular product 402 is facing the light can then change based on the tilt, rotation, or movement.

If the lenticular product 402 is then tilted, rotated, or moved again by another threshold amount, the specific image magnified into focus can change again based on the tilt, rotation, or movement. The images 404A-404D to be magnified can continue to change as the lenticular product 402 continues to tilt, rotate, or move. This change can be sequential such that the change of images follows a particular order throughout the rotation or movement.

To further illustrate, if image 404A is magnified into focus when the lenticular product 402 is facing the light, the rotation of the lenticular product 402 can cause the images 404A-404D to change with 404B being the first image after image 404A, 404C being the next image after image 404B, and 404D being the next image after 404C. After image 404D, image 404A can be magnified into focus if the lenticular product 402 continues to tilt or rotate in the same direction, and 404C would be magnified into focus if the lenticular product 402 begins to tilt or rotate in the opposite direction. This way, a full tilt or rotation of the lenticular product 402, for example, would cause the images 404A-404D to be magnified into focus in the specific order of 404A first, 404B second, 404C third, and 404D fourth. This cycle would continue according to the same pattern as the lenticular product 402 continues to tilt or rotate in the same direction.

Moreover, the specific image to be magnified can depend not only on the amount of rotation (e.g., 10 degrees versus 15 degrees versus 30 degrees) but also the direction. For example, if the currently-magnified image is image 404B and the lenticular product 402 is rotated a threshold amount to the left, the newly-magnified image can be image 404A. On the other hand, if the same rotation is instead performed to the right, the newly-magnified image can instead be image 404C. As another example, if the currently-magnified image is image 404B and the lenticular product 402 is moved up a threshold amount relative to the viewer's eyes, the newly-magnified image can become 404C. On the other hand, if the lenticular product is instead moved down by the threshold amount, the newly-magnified image can instead be 404A. In addition, the specific image to be magnified can depend on the direction of movement, such as forward/backward, up/down and/or left/right. Indeed, the image magnified to the viewer can depend on the location, position, distance, angle, motion, or movement of the lenticular product with respect to the viewer.

The tilt or rotation of images can thus cause the lenticular product 402 to exhibit a lenticular effect where the object(s) in the images 404A-404D appears to be animated, or otherwise visually modified, based on the specific changes between the images 404A-404D. For example, in the non-limiting example of FIGS. 4A-4D, images 404A-404D illustrate a soccer player in various stances. The stances depict the various positions or steps of the soccer player when executing a roll stepover 406 move. Thus, as the various images 404A-D are magnified into focus, the soccer player in the lenticular product 402 will appear to be changing from one stance to another, which would create the illusion that the soccer player is actually moving according to the various steps represented by the images 404A-404D. More specifically, the soccer player will appear to be executing the roll stepover 406 move represented by the combined images 404A-404D. Accordingly, the lenticular product 402 will depict a soccer player which will appear to execute each of the steps in the roll stepover 406 move sequentially as the lenticular product 402 is tilted or rotated (or moved in a manner that changes the angle of the lenticular product 402 relative to the light).

The lenticular effect exhibited by the lenticular product 402 can be created by the lenticular lenses 104A-I in the lenticular sheet 102 and the images 404A-404D. Here, the lenticular lenses 104A-I can cause specific images to be magnified into focus based on the specific angle of the lenticular product 402 with respect to the surrounding light or light source. To this end, the images 404A-404D can be spliced into frames and the frames interlaced. The interlaces can then be arranged and aligned with the lenticular lenses 104A-I such that specific frames from specific images are magnified together at precise angles, and other frames from other images are be magnified at other angles, so that specific images are magnified when the lenticular product 402 is positioned at respective angles relative to the light or light source.

Furthermore, the images 404A-404D in the lenticular product 402 can be representative of a specific view of the desired lenticular effect. For example, in some embodiments, the combination of the images 404A-404D can represent a particular sports move. Here, the lenticular effect generated by the lenticular product 402 can be an animation of the execution of the particular sports move depicted by the combination of images 404A-404D. In other cases, the images 404A-404D can vary to depict other objects, moves, animations, effects, symbols, steps, etc. For example, different lenticular products can be created to illustrate different sports or exercise moves, different movements, different activities, or different visual effects. In some cases, different lenticular products can be generated to illustrate different exercise moves, training steps, educational activities, steps in a tutorial, steps in a manual, etc. The images in each lenticular product can vary based on the desired lenticular effect, as well as the specific underlying theme and context intended to be captured.

The lenticular product 402 can include a description 406 of the specific lenticular effect exhibited by the lenticular product 402. For example, the description 406 can specify the name of the move depicted by the images 404A-404D in the lenticular product 402, such as roll stepover. The description 406 can be configured to be static, but can alternatively be configured to exhibit some form of lenticular effect. For example, the description 406 can be configured to change in size, shape, and/or color as the lenticular product 402 is rotated or moved.

FIG. 5 illustrates a back view 500 of a lenticular product in accordance with an exemplary embodiment. The back view 500 can illustrate the back of a backing layer 502 of a lenticular product, such as lenticular product 402 illustrated in FIGS. 4A-D. The backing layer 502 can depict steps 504-510, which can correspond to the particular steps performed to execute a move, such as a sports move. In the example of FIG. 5, the steps 504-510 illustrate the steps performed to execute the roll stepover 406 move depicted by the images 404A-404D according to the front views 400A-D of the lenticular product 402. In other words, the steps 504-510 can visually explain the steps needed to perform a particular move, and the front views 400A-D of the lenticular product 402 can exhibit a lenticular effect that depicts an animation of the move being performed. This way, a user can refer to the back view 500 for an explanation of the steps that need to be performed to execute a particular move, and can then view an animation of the move through the lenticular effect created by the front views 400A-D on the front of the lenticular product 402. Thus, the back view 500 can teach a user how to perform a move, gesture, activity, step, trick, or any other movement, and the front views 400A-D can visually show the user how that particular move, gesture, activity, step, trick, or movement, appears when executed. To this end, the images 404A-D can, in some cases, correspond to the steps 504-510. However, in other cases, the images 404A-D may not match or correspond to the steps 504-510.

Each of the steps 504-510 can include one or more images depicting the various positions, stances, or movements within each step, as well as an explanation or description of the specific step. For example, step 1 (504) can display images 512-516 to illustrate the various movements, from beginning to end, necessary to perform step 1 (504). A description 518 can also be provided explaining how to perform the various movements represented by the images 512-516 in step 1 (504). Similarly, step 2 (506) can display images 520-524 to illustrate the various movements, from beginning to end, necessary to perform step 2 (506), and a description 526 explaining how to perform the various movements represented by the images 520-524 in step 2 (506). Step 3 (508) can display images 528-532 to illustrate the various movements, from beginning to end, necessary to perform step 3 (508), and a description 534 explaining how to perform the various movements represented by the images 528-532 in step 3 (508). Finally, step 4 (510) can display images 536-540 to illustrate the various movements, from beginning to end, necessary to perform step 4 (510), and a description 542 explaining how to perform the various movements represented by the images 536-540 in step 4 (510).

In some embodiments, each of the steps 504-510 in the back view 500 can correlate to a lenticular view from the views 404A-D in the front of the lenticular product 402. Thus, the steps 504-510 can have a functional relationship with the steps depicted by each of the views 404A-D. For example, step 504 can provide a graphical and textual explanation of the animated step exhibited by the lenticular product 402 through view 404A, and steps 506-510 can provide graphical and textual explanations of the animated steps exhibited by the lenticular product through views 404B-D, respectively. As such, a user can refer to step 1 (504) from the back view 500 to obtain an explanation of how that step can be performed, and also refer to view 404A from the front of the lenticular product 402, to see an animation of step 1 (504).

As one of ordinary skill in the art will readily recognize, the back view 500 can include more or less steps, figures, or descriptions than those depicted in FIG. 5. For example, the back view 500 can depict a different number of steps, figures, or descriptions based on the overall movement, gesture, activity, behavior, etc., intended to be explained in back view 500. In some cases, the number of steps, figures, or descriptions in back view 500 can depend on the level of explanation desired, the level of complexity of the steps, the size of the lenticular product, or any other reason. The number of steps, figures, descriptions, in FIG. 5, and the level of specificity of the back view 500, are shown as a non-limiting example for explanation purposes. One of ordinary skill in the art will readily recognize that other implementations may vary. Moreover, while steps 1-4 (504-510) are depicted in FIG. 5 using images and text, other implementations are contemplated herein. For example, the steps 1-4 (504-510) can be depicted using images, text, symbols, colors, patterns, numbers, etc., either alone or in combination. Indeed, the steps 1-4 (504-510) can, in some embodiments, be depicted using animations, such as an animated step produced by lenticular lenses on the backing layer 502.

In addition, in some cases, the back view 500 can depict instruction panels corresponding to the steps 504-510. Here, each of the instruction panels can provide visual and/or textual explanations of the various steps involved in performing the movement depicted by the images 404A-D on the front of the lenticular product 402. However, in other cases, the back view 500 can depict instruction panels that do not match or correspond to the steps involved in performing the movement depicted by the images 404A-D on the front of the lenticular product 402. For example, the instruction panels can correspond to steps performed prior, or in addition, to the movement depicted by the images 404A-D on the front of the lenticular product 402. As another example, the instruction panels can correspond to substeps within the overall movement depicted by the images 404A-D on the front of the lenticular product 402. Here, the instruction panels can provide a more granular explanation of the overall movement depicted by the images 404A-D on the front of the lenticular product 402.

In some embodiments, the back view 500 can include a tip printed on the backing layer 502. The tip can provide instructions or additional information explaining how to perform the steps 504-510 and/or the movement depicted by the images 404A-D. For example, additional information that may be useful to a viewer in learning how to execute the movement depicted by the images 404A-D or the steps 504-510 can be printed as a tip on the backing layer 502. The tip information, in some cases, can relate to the overall movement or execution of the movement. In other cases, the tip information can relate to information that may not be adequately or sufficiently conveyed by the images 512-516, 520-524, 528-532, and 536-540 on the backing layer 502 and/or the images 404A-D on the front of the lenticular product 402. For example, the tip information can provide convey specific tricks on how to execute the move or steps, which may not be so readily ascertainable by typical viewers who are unexperienced in performing the particular move or steps.

In other embodiments, the back view 500 can include a link to an external resource, such as a website, a server, an application, or an address. For example, the back view 500 can include a link to download an application, such as a smartphone application, or a link to view or access a video on a website. Links to other resources, such as other web or server resources, are also contemplated herein. Moreover, the link can be provided in one or more forms or formats. For example, in some cases, the link can be provided as a URL website address. In other cases, the link can be provided as a quick response (QR) code that points to an external resource. The external resource can be, for example, a website or download link having one or more videos and/or instructions that further explain the move or action conveyed by the steps 504-510 and/or images 404A-D, or otherwise provide additional instructions using other teaching techniques. In still other embodiments, the link can point to an application, such as a mobile application, that provides additional information, such as instructional information related to the move or action.

The link can also be provided in other forms or indicia. For example, the link can be provided using other forms of images or symbols. Those examples provided herein are non-limiting examples for explanation purposes. Also, while the above examples describe one link, more links are also contemplated herein. For example, the back view 500 can include multiple links to multiple resources. In some cases, the back view 500 can include one or more links for each of the steps 504-510.

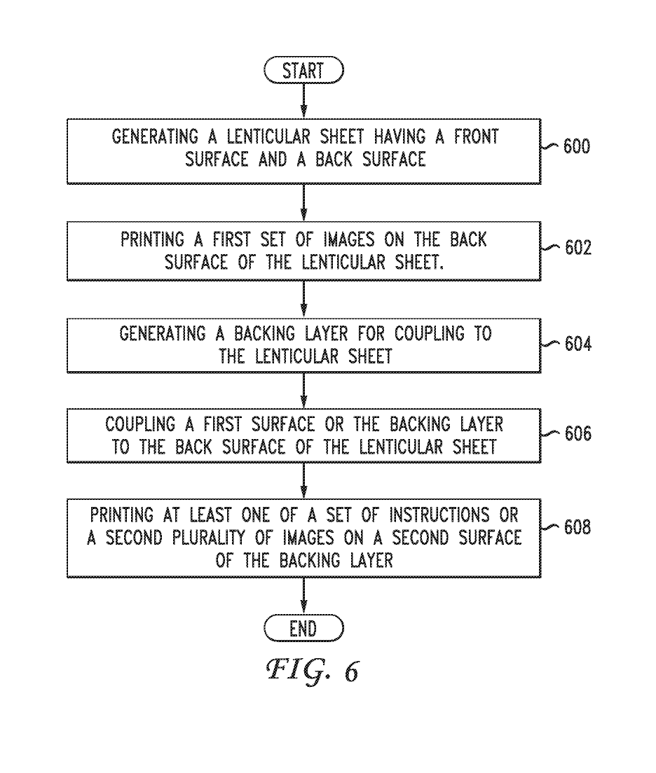

Having disclosed some basic system components and concepts, the disclosure now turns to FIG. 6, which shows a method in accordance with an exemplary embodiment. The steps outlined herein are exemplary and can be implemented in any combination thereof, including combinations that exclude, add, or modify certain steps.

At step 600, the method first generates a lenticular sheet having a front surface and a back surface, the front surface including an array of lenticular lenses. The lenticular lenses can refer to lenticules suitable for creating a lenticular effect using multiple images. The lenticular effect can be an animation, a video, a movement, an activity, a gesture, a visual effect, a three-dimensional effect, a distortion, a depth, a sports move, or any optical illusion.

At step 602, the method includes printing a first set of images on the back surface of the lenticular sheet. Each of the first set of images can be arranged into frames, the frames being interlaced with other frames corresponding to similarly arranged images from the first set of images. Each of the frames can be aligned with at least one of the lenticular lenses such that light reflected from frames associated with a same image are refracted in a same direction and frames reflected from frames associated with a different image are refracted in a different direction. The images in the first set of images can represent the various views that in combination create the desired lenticular effect. For example, if the desired lenticular effect is an animation of a soccer move, the first set of images can represent the various positions, steps, or stances involved in performing the specific soccer move. Thus, as the different images in the first set of images are magnified into focus at different angles, the first set of images will appear to create an animation of the soccer move. The lenticular lenses in the lenticular sheet can be configured to create the animation by ensuring that the appropriate frames from the lenses are magnified at specific angles relative to the light, to create the desired lenticular effect.

At step 604, the method includes generating a backing layer for coupling to the lenticular sheet, and at step 606, coupling a first surface of the backing layer to the back surface of the lenticular sheet. When coupled to the lenticular sheet, the backing layer and lenticular sheet can form a lenticular product, such as a lenticular card, for example. In some embodiments, the first surface of the backing layer can have one or more images from the first set of images printed on it. These images can be used to create or modify the desired lenticular effect. For example, in some cases, the first set of images used to create the lenticular effect can be printed on the first surface of the backing layer instead of, or in addition to, the back surface of the lenticular sheet. In other cases, one or more images from the first set of images can be printed on the back surface of the lenticular sheet, and the remaining images needed to create the lenticular effect can be printed on the first surface of the backing layer. This way, images can be printed on both the lenticular sheet and the backing layer in order to make use of both the back surface of the lenticular sheet and the first surface of the backing layer.

At step 608, the method can include printing instructions and/or a second set of images on a second surface of the backing layer. The second surface can be opposite of the first surface of the backing layer. The second set of images can represent a series of actions. Moreover, the instructions printed can correspond to the series of actions. In some cases, the instructions can be printed with the second set of images. However, in other embodiments, the method can include printing instructions without the images, or the images without instructions. Thus, the specific scheme or configuration can vary based on specific preferences, goals, requirements, context, applications, or the specific lenticular product or effect desired.

Furthermore, the series of actions can refer to the various steps, movements, gestures, activities, and/or actions performed when executing a particular action. In some embodiments, such particular action can refer to the same action depicted in the lenticular effect through the first set of images. Thus, the second set of images can provide illustrations and instructions for performing the steps necessary to execute an action depicted through the lenticular effect created by the first set of images and the lenticular lenses on the lenticular sheet. Accordingly, the user can refer to the second surface of the backing layer to obtain a visual and/or textual explanation of the steps, and look at the lenticular effect generated by the lenticular sheet to obtain an animation of the steps described on the backing layer.

The combination of the backing layer and the lenticular sheet can result in a lenticular product that a user can use to obtain both a description of a particular move and an animation illustrating the particular move. Thus, the user can use the lenticular product to both read about a move and see how the move is performed in an animated form.

The lenticular effect produced by the lenticular product can be based on the angle of the lenticular lenses and the first set of images relative to the light. The lenticular lenses can be irregularly shaped (i.e., non-planar) to ensure that light is refracted from different frames in the interlace depending on the angle of the lenticular product relative to the light. The different frames in the interlace can also be precisely aligned and/or arranged with specific lenticular lenses to ensure the desired lenticular effect is created when light passes through the lenticular lenses at specific angles.

In some embodiments, the lenticular lenses can ensure that the frames magnified when light is at a specific angle relative to the lenticular product all belong to the same image, and frames from other images are magnified as the angle changes. This can create the particular lenticular effect by ensuring that different images are magnified as the angle changes (i.e., as the lenticular product is moved or rotated). The lenticular lenses can have longitudinal cylindrical axes which may be arranged in parallel throughout the lenticular sheet. This shape can be leveraged with the first set of images to ensure that light beams at specific angles are refracted from specific frames from specific images to be magnified in order to create the desired lenticular effect. Moreover, the lenticular lenses can include varying scales, proportions, or optical prescriptions to generate the desired lenticular effect. The first set of images can be interlaced at a pitch substantially commensurate with the pitch of the lenticular lenses in the lenticular sheet. The interlaced image can be a single pass, but can also include registered printing of a series of color separations.

The irregular shape of the lenticular lenses can result in gaps or grooves in the lenticular sheet, or may otherwise result in an irregular surface. However, in some embodiments, the method can include placing a coating material over the lenticular sheet to fill the gaps or grooves created by the lenticular lenses, or otherwise create a smooth, flat surface of the lenticular sheet. The coating material can also be used to create a window or screen over a portion of the lenticular sheet, as previously described in FIGS. 2 and 3. The coating material can be clear or transparent. Moreover, the window or screen can be an optical window or screen.

Furthermore, the resulting lenticular product created by the lenticular sheet and the backing layer can be, for example, a lenticular card, a lenticular pamphlet, a lenticular cover, a lenticular billboard, a lenticular screen, an advertisement, a lenticular manual, a lenticular object, and so forth. In some embodiments, the lenticular product can be an educational card providing instructions and animations of specific steps.

As previously explained, the lenticular product can be implemented in a wide variety of contexts, such as, for example, yoga, physical therapy, chiropractor exercises, fitness/workout, dancing, karate, tae kwon do, stretching, pregnancy labor, arts, crafts, acting, cooking, engineering, design, computing, building or repairing items, or any other activities. To this end, the backing layer can include instructions that are specifically tailored for the context of the lenticular product. For example, the backing layer of the lenticular product can include instructions for yoga movements/positions; physical therapy exercises, positions, or instructions; chiropractor exercise instructions, movements, postures, or positions; fitness/workout movements, exercises, or activities; dancing steps, movements, styles, or activities; moves, punches, kicks, or defensive and offensive tricks for karate, tae kwon do, martial arts, boxing, or any self-defense art; stretching exercises, movements, or steps, or positions, pregnancy labor positions, exercises (e.g., breathing and labor exercises), tricks, or practice steps; arts or craft activities, steps, or tasks; acting steps, actions, activities, or tricks; or virtually any other context for any activity—all which can depend on the relevant context of the lenticular product.

In addition, the lenticular product can include tips or other functional and instructional language and objects—either in the backing layer, the lenticular sheet, or both—that supplements or further defines the instructions in the backing layer, the images in the front surface of the lenticular product (e.g., the lenticular sheet), and/or the images in the back surface of the lenticular product (e.g., the backing layer). Such tips or other functional or instructional language and objects can also depend (or be relevant to) the specific context of the lenticular product. For example, the tips or other functional or instructional language and objects can be based on yoga, physical therapy, chiropractor exercises, fitness/workout, dancing, karate, tae kwon do, stretching, pregnancy labor, arts, crafts, acting, cooking, engineering, design, computing, building or repairing items, or any other activities.

Furthermore, as previously suggested, the context can also affect the images either on the front surface of the lenticular product (e.g., the lenticular sheet), and/or the images in the back surface of the lenticular product (e.g., the backing layer). In other words, any of the images can be based on the context of the lenticular product. For example, if the context of the lenticular product is yoga or dancing, any of the images can be based on yoga or dancing moves, steps, actions, positions, or activities. In this example, the images on the lenticular product can define the specific yoga or dancing moves, steps, actions, positions, or activities. The lenticular effect—previously defined—can also be designed to illustrate, represent, plot, perform, instruct, highlight, define, or in any way visualize any aspects of such yoga or dancing moves, steps, actions, positions, or activities.

As another example, if the context of the context of the lenticular product is based on a specific activity, such as an exercise, a routine, or a sequence of moves, then the images (either images on the front of the lenticular product, the back, or both) can be based on such context. To this end, the images can represent, define, highlight, instruct, perform, plot, or illustrate such activity, including any steps, movements, changes, actions, activities, gestures, or details of the activity. Similarly, the lenticular effect can illustrate, represent, highlight, instruct, perform, plot, define, or in any way visualize any aspects of such activity.

Those of skill in the art will readily recognize that other embodiments can include a different number or type of contexts, images, instructions, activities, tips, steps, positions, motions, moves, lenticular effects, implementations, actions, and illustrations than those described above. However, the examples above are non-limiting examples provided for the sake of clarity and simplicity. Indeed, other lenticular products, example, activities, steps, implementations, etc., are contemplated herein.

The various components of the lenticular product can provide visual effects and functionality, but can also provide structure, support, and protection for the images used to generate the lenticular effect. The lenticular effect can also provide various effects and themes, including animations, color shifts, transformations, spatial illusions, changes in size or shape, etc.

The various embodiments described above are provided by way of illustration only and should not be construed to limit the scope of the disclosure. Various modifications and changes may be made to the principles described herein without following the example embodiments and applications illustrated and described herein, and without departing from the spirit and scope of the disclosure. Claim language reciting “at least one of” a set indicates that one member of the set or multiple members of the set satisfy the claim.

We claim:

1. A lenticular product comprising:
a lenticular sheet having a front surface and a back surface, the front surface comprising an array of lenticular lenses;
a graphic printed on the back surface of the lenticular sheet, the graphic comprising a first plurality of images depicting a sports move, each of the first plurality of images depicting a part of the sports move, wherein each of the first plurality of images is arranged into frames, the frames being interlaced with other frames corresponding to similarly arranged images from the first plurality of images, wherein each of the frames is aligned with at least one of the lenticular lenses such that light reflected from frames associated with a same image are refracted in a same direction and frames reflected from frames associated with a different image are refracted in a different direction;
a backing layer having a first surface coupled to the back surface of the lenticular sheet and a second surface opposite of the first surface; and
at least one of a second plurality of images or a set of instructions printed on the second surface of the backing layer, the second plurality of images representing a series of steps for performing the sports move, wherein the set of instructions define the series of steps for performing the sports move.

2. The lenticular product of claim 1, wherein the second plurality of images comprises images showing steps for performing the sports move, the lenticular product further comprising a tip printed on the second surface of the backing layer, the tip comprising instructions related to the sports move, the instructions providing a further explanation for performing the sports move.

3. The lenticular product of claim 1, the second surface having a first surface area comprising a first subset of images from the second plurality of images and a second surface area comprising a second subset of images from the second plurality of images, wherein each of the first subset of images and the second subset of images comprises images depicting respective steps associated with the sports move.

4. The lenticular product of claim 3, wherein the first surface area and the second surface area further comprise instructions for performing the respective steps.

5. The lenticular product of claim 1, further comprising an adhesive layer on the first surface of the backing layer coupled to the back surface of the lenticular sheet.

6. The lenticular product of claim 1, further comprising a clear coating deposited over at least a portion of the front surface of the lenticular sheet, the clear coating filling gaps between the lenticular lenses on the front surface of the lenticular sheet, wherein the first plurality of images are viewable through the clear coating.

7. The lenticular product of claim 1, wherein the lenticular lenses comprise lenticules, and wherein the first and second plurality of images comprise photographs.

8. The lenticular product of claim 1, further comprising text printed on the back surface of the lenticular sheet, the text being based on the first plurality of images.

9. The lenticular product of claim 1, wherein each of the frames is aligned with at least one of the lenticular lenses to exhibit a lenticular effect.

10. The lenticular product of claim 9, wherein the lenticular effect comprises at least one of a movement of an image associated with the first plurality of images depicting the sports move or an animation of the sports move.

11. The lenticular product of claim 1, wherein the lenticular product is a lenticular card displaying a lenticular effect associated with an action based on the first plurality of images, the lenticular effect being further illustrated by the second plurality of images.

12. A method comprising:
generating a lenticular sheet having a front surface and a back surface, the front surface comprising an array of lenticular lenses;
printing a graphic on the back surface of the lenticular sheet, the graphic comprising a first plurality of images depicting a sports move, each of the first plurality of images depicting a part of the sports move, wherein each of the first plurality of images is arranged into frames, the frames being interlaced with other frames corresponding to similarly arranged images from the first plurality of images, wherein each of the frames is aligned with at least one of the lenticular lenses such that light reflected from frames associated with a same image are refracted in a same direction and frames reflected from frames associated with a different image are refracted in a different direction;
generating a backing layer for coupling to the lenticular sheet;
coupling a first surface of the backing layer to the back surface of the lenticular sheet; and
printing at least one of a set of instructions or a second plurality of images on a second surface of the backing layer, the second surface being opposite of the first surface of the backing layer, the second plurality of images representing a series of steps for performing the sports move, wherein the set of instructions define the series of steps for performing the sports move.

13. The method of claim 12, wherein coupling the first surface of the backing layer to the back surface of the lenticular sheet forms a lenticular product that exhibits a lenticular effect based on at least one of the first plurality of images or an angle of light relative to at least one of the lenticular lenses or the first plurality of images.

14. The method of claim 12, wherein the lenticular lenses comprise lenticules, the method further comprising printing a tip on the second surface of the backing layer, the tip comprising instructions related to the sports move, the instructions providing a further explanation for performing the sports move.

15. The method of claim 12, wherein coupling the first surface of the backing layer to the back surface of the lenticular sheet comprises adhering the first surface of the backing layer to the back surface of the lenticular sheet.

16. The method of claim 15, wherein the adhering is performed using an adhesive layer.

17. The method of claim 12, further comprising covering at least a portion of the front surface of the lenticular sheet with a coating material that fills gaps between the lenticular lenses created by a respective shape of the lenticular lenses.

18. The method of claim 17, wherein the coating material comprises a clear coating, the clear coating allowing light to be reflected from the frames to create a lenticular effect.

19. The method of claim 12, further comprising printing text on the back surface of the lenticular sheet, the text being based on the first plurality of images.

20. The method of claim 12, further comprising printing text on the second surface of the backing layer, the text comprising a tip related to the sports move.
